(19) United States
(12) Patent Application Publication
(10) Pub. No.: US 2020/0129359 A1
(43) Pub. Date: Apr. 30, 2020

(54) MOBILE INVERTED PENDULUM

(71) Applicant: TOYOTA JIDOSHA KABUSHIKI KAISHA, Toyota-shi (JP)

(72) Inventors: Hiroshi HIRAIWA, Toyota-shi (JP); Takeshi KAMA, Nagakute-shi (JP); Yusuke HARA, Nagoya-shi (JP); Takahiro SHIGA, Chiryu-shi (JP)

(73) Assignee: TOYOTA JIDOSHA KABUSHIKI KAISHA, Toyota-shi (JP)

(21) Appl. No.: 16/538,909

(22) Filed: Aug. 13, 2019

(30) Foreign Application Priority Data
Oct. 25, 2018 (JP) 2018-201027

(51) Int. Cl. A61H 1/00; B62K 11/00; B62J 99/00

(52) U.S. Cl. CPC A61H 1/005; B62K 11/007; B62J 99/00; B62J 2099/002; B62J 2099/004; A61H 2201/5069; A61H 2230/625; A61H 2201/5048; A61H 2201/0188; A61H 2201/5007; A61H 2201/0157; B62J 2099/008

(57) ABSTRACT

A mobile inverted pendulum includes a step on which a foot of a rider is placed, a vibration applying device that applies vibration to the step, and a vibration control unit that controls operation of the vibration applying device.

### INCORPORATION BY REFERENCE

The disclosure of Japanese Patent Application No. 2018-201027 filed on Oct. 25, 2018 including the specification, drawings and abstract is incorporated herein by reference in its entireness.

### BACKGROUND

### 1. Technical Field

The disclosure relates to mobile inverted pendulums.

### 2. Description of Related Art

Various mobile inverted pendulums that a user can ride and operate have been proposed. For example, Japanese Unexamined Patent Application Publication No. 2006-315666 (JP 2006-315666 A) discloses a mobile inverted pendulum that a user rides and operates in a standing position. The user (hereinafter referred to as a “rider”) can control the traveling direction of the mobile inverted pendulum by actions such as operating the handlebars, moving the position of the center of gravity, and changing the inclination of the steps.

### SUMMARY

Batteries etc. for mobile inverted pendulums have been improved, and traveling for a long time and long distance have become possible. However, the rider has to operate the mobile inverted pendulum while standing and changing their posture to some extent. Thus, a long-time riding causes load to concentrate on specific parts of the rider's body (especially, soles, etc.) so that the rider feels a strong sense of fatigue.

The disclosure relates to a mobile inverted pendulum, and provides a technology that can reduce fatigue accumulated in specific parts of a rider's body in accordance with a riding time and the like.

A mobile inverted pendulum according to an aspect of the disclosure includes a step on which a foot of a rider is placed, a vibration applying device that applies vibration to the step, and a vibration control unit that controls operation of the vibration applying device.

The mobile inverted pendulum according to the above aspect may further include a posture sensor that detects a posture angle of the mobile inverted pendulum. The vibration control unit may allow the vibration applying device to apply vibration when the detected posture angle is within a set allowable range of the posture angle.

The vibration control unit may stop application of vibration by the vibration applying device when the detected posture angle falls below a set posture angle threshold with the vibration being applied to the step.

The mobile inverted pendulum according to the above aspect may further include a notification unit that notifies the rider about operation of the vibration applying device before the vibration is applied.

The mobile inverted pendulum according to the above aspect may further include an operation handlebar held by the rider and an auxiliary vibration applying device that applies vibration to the operation handlebar.

The mobile inverted pendulum according to the above aspect may further include an input unit through which the rider inputs a control command related to the operation of the vibration applying device.

The mobile inverted pendulum according to the above aspect may further include a distance sensor that measures a moving distance of the mobile inverted pendulum. The vibration control unit may control the operation of the vibration applying device based on the measured moving distance.

The mobile inverted pendulum according to the above aspect may further include a timer that measures a riding time of the rider. The vibration control unit may control the operation of the vibration applying device based on the measured riding time.

According to the disclosure, it is possible to reduce fatigue accumulated, depending on a riding time and the like, in specific body parts of a rider operating a mobile inverted pendulum.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a perspective view showing a schematic configuration of a mobile inverted pendulum according to an embodiment;

FIG. 2 is a block diagram showing a system configuration of the mobile inverted pendulum;

FIG. 3 is a flowchart showing a vibration control process; and

FIG. 4 is a block diagram showing a system configuration of a mobile inverted pendulum according to a modification.

### DETAILED DESCRIPTION OF EMBODIMENTS

Embodiments will be described with reference to the accompanying drawings. In the drawings, those denoted by the same reference character have the same structure.

### A. Embodiment

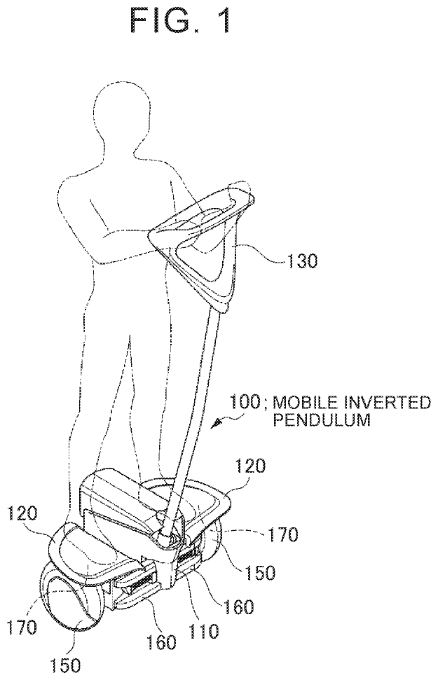

FIG. 1 is a perspective view showing a schematic configuration of a mobile inverted pendulum 100 according to an embodiment.

The mobile inverted pendulum 100 is a coaxial two-wheeled vehicle that can move while controlling a pair of wheels 150 individually to maintain an inverted state. The mobile inverted pendulum 100 includes a vehicle body 110, a pair of right and left step units 120, an operation handlebar 130, a pair of right and left wheels 150, drive units 160, and vibration units 170. The step units 120 are attached to the vehicle body 110, and the rider stands on the step units 120. The operation handlebar 130 is tiltably attached to the vehicle body 110 and the rider holds the operation handlebar 130. The wheels 150 are rotatably attached to the vehicle body 110. The drive units 160 drive the wheels 150. The vibration units 170 applies vibration to soles of the rider on the mobile inverted pendulum 100.

The rider shifts their center of gravity forward and backward to tilt each step unit 120 attached to the body 110 forward and backward, thereby enabling the mobile inverted pendulum 100 to travel forward and backward. The rider shifts their center of gravity to the right and left to tilt the step units 120 attached to the vehicle body 110 to the right and left, thereby enabling the mobile inverted pendulum 100 to turn right and left.

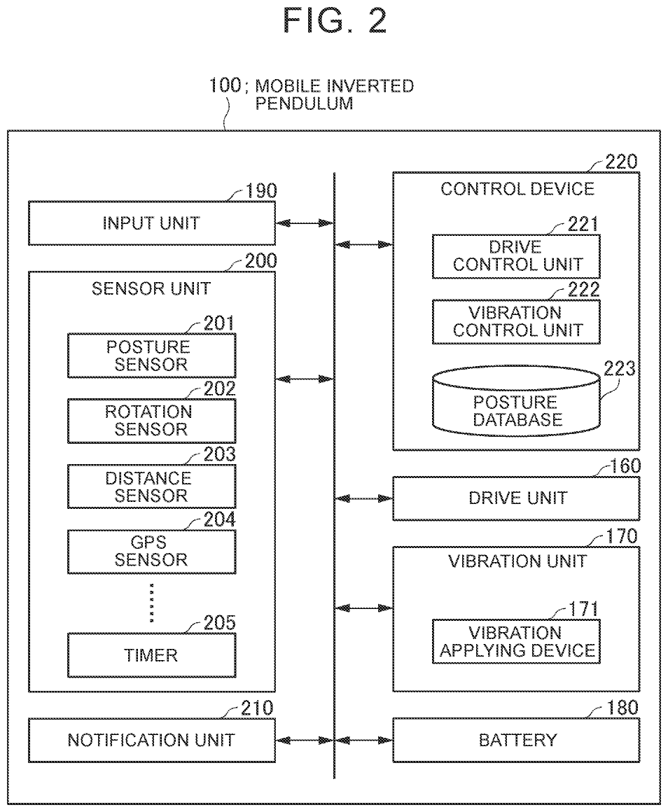

FIG. 2 is a block diagram showing a system configuration of the mobile inverted pendulum 100. The drive units 160 are built in the vehicle body 110, and each include an electric motor and various gears. The drive units 160 cause the mobile inverted pendulum 100 to travel, and perform self-balancing control such that the mobile inverted pendulum 100 does not fall down, under the control by the control device 220.

The vibration units 170 are attached to the backsides of the step units 120 and each include a vibration applying device 171. The vibration applying devices 171 apply vibration that stimulates the soles (that is, massages the soles) of the rider on the step units 120, under the control by the control device 220. The vibration applying devices 171 each include a motor, an eccentric cam, a pulley, a link mechanism, and the like. The rotation of the motor is converted into vertical vibration via the pulley, the link mechanism, etc., which can stimulate the soles of the rider. Protrusions or recesses may be formed on the surface of each step unit 120 so that the soles of the rider can be more effectively stimulated even when the rider is wearing shoes.

A power supply unit (battery) 180 is built in the vehicle body 110, and is a lithium ion battery or the like. The power supply unit 180 supplies power to various devices constituting the mobile inverted pendulum 100, other electronic devices, and the like.

An input unit 190 is provided in the vicinity of the operation handlebar 130, and includes operation buttons, operation switches, a touch panel, a sound collector that enables voice input, and the like. The rider operates the input unit 190 appropriately to input a control command related to the operation of the vibration applying devices 171. Examples of the control command include a command to start application of vibration, a command to end application of vibration, and commands regarding a vibration intensity, a vibration cycle, a vibration mode, etc., but are not limited thereto.

A sensor unit 200 is built in the vehicle body 110, and includes various measuring instruments such as a posture sensor 201, a rotation sensor 202, a distance sensor 203, a GPS sensor 204, and a timer 205. The posture sensor 201 is provided in the vehicle body 110, and detects and outputs posture information of the vehicle body 110, the operation handlebar 130, and the like. The posture sensor 201 detects posture information of the mobile inverted pendulum 100 during traveling, and includes a gyro sensor, an acceleration sensor, and the like. When the rider tilts the operation handlebar 130 forward or backward, each step unit 120 tilts in the same direction. The posture sensor 201 detects posture information (so-called three-dimensional posture angle, etc.) corresponding to that tilt. The posture sensor 201 outputs the detected posture information to the control device 220.

The rotation sensor 202 is provided on each of the wheels 150 and the like, and detects rotation information such as a rotation angle, a rotation angular velocity, and a rotation angular acceleration of each wheel 150. Each rotation sensor 202 is a rotary encoder, a resolver, or the like. Each rotation sensor 202 outputs the detected rotation information to the control device 220.

The distance sensor 203 is provided in the vehicle body 110 and detects distance information representing a moving distance of the mobile inverted pendulum 100. The distance sensor 203 outputs the detected distance information to the control device 220.

The GPS sensor 204 is, for example, a part of a positioning system using artificial satellites, and receives radio waves from GPS satellites to determine the position (longitude, latitude, altitude, etc.) of the mobile inverted pendulum 100. The GPS sensor then outputs the position information to the control device 220.

The timer 205 measures a riding time of the mobile inverted pendulum 100 by the rider. Here, the riding time refers to a period from a time when the rider steps on to a time when the rider steps off. After measuring the riding time, the timer 205 outputs the measured riding time to the control device 220 as riding time information.

A notification unit 210 includes a speaker that outputs sounds, a lamp that illuminates/flashes for warning, and a display that shows a warning. The notification unit 210 provides notification to the rider based on a notification signal from the control device 220.

The control device 220 include a central processing unit (CPU), a read only memory (ROM), a random access memory (RAM), and the like, and serves as a control center for controlling the mobile inverted pendulum 100. The control device 220 includes a drive control unit 221 and a vibration control unit 222.

The drive control unit 221 generates and outputs control signals for controlling the drive unit 160 based on detection values output from the various sensors mounted on the mobile inverted pendulum 100. For example, the drive control unit 221 executes a predetermined arithmetic process based on the posture information output from the posture sensor 201, the rotation information of the wheels 150 output from the rotation sensor 202, so as to generate control signals necessary to cause the mobile inverted pendulum 100 to move at a predetermined speed while maintaining its self-balancing state. Then, the drive control unit 221 outputs the generated control signals to the drive unit 160.

The vibration control unit 222 generates and outputs control signals for controlling the operation of the vibration applying device 171 based on a detected value and the like output from the input unit 190 or the sensor unit 200. Examples of the control by the vibration control unit 222 include the following methods, but are not limited thereto. The operation of the vibration applying device 171 may be controlled by appropriately combining two or more of the following methods.

### Method of Using Input Unit 190

When receiving a control command related to the operation of the vibration applying device 171 from the operation button or the like of the input unit 190, the vibration control unit 222 generates a control signal for controlling the operation of the vibration applying device 171 in accordance with the control command and outputs the control signal to the vibration applying device 171. By appropriately operating the operation button, the touch panel, or the like provided near the operation handlebar 130 (or by providing a voice input), the rider can provide a stimulus to their soles at a desired timing regardless of whether the mobile inverted pendulum 100 is traveling or not.

### Method of Using Posture Sensor

When receiving the posture information from the posture sensor 201, the vibration control unit 222 refers to allowable posture angle information stored in a posture database 223 to determine whether to allow application of vibration by the vibration applying device 171. The allowable posture angle information is information representing such an allowable range of the posture angle that the vibration control unit 222 can determine that the application of vibration does not interfere with traveling of the mobile inverted pendulum 100, for example. When the vibration control unit 222 determines that the application of vibration by vibration applying device 171 can be permitted, the vibration control unit 222 generates a control signal to start (or continue) the application of vibration based on the posture information received from the posture sensor 201 and outputs the control signal to the vibration applying device 171.

Instead of determining whether to allow the application of vibration, the vibration control unit 222 may use a posture angle threshold to control the operation of the vibration applying device 171. In this case, the posture angle threshold defines a posture angle to stop the application of vibration and is stored in the posture database 223. Specifically, when detecting that the posture angle represented by the posture information falls below the posture angle threshold, the vibration control unit 222 generates a control signal to stop the application of vibration by the vibration applying device 171, and outputs the control signal to the vibration applying device 171. The allowable posture angle information and the posture angle threshold stored in the posture database 223 may be set as appropriate by a service provider who maintains and supervises the mobile inverted pendulum 100.

### Method of Using Distance Sensor

The vibration control unit 222 generates a control signal for controlling the operation of the vibration applying device 171 based on distance information output from the distance sensor 203, and outputs the control signal to the vibration applying device 171. The distance information output from the distance sensor 203 includes information indicating a total moving distance from the start of the riding, as well as information indicating the moving distance from a point of latest stoppage such as waiting at a traffic light. The vibration control unit 222 estimates a degree of fatigue accumulation on the rider's soles, based on the distance information supplied from the distance sensor 203. When the vibration control unit 222 determines that the estimated degree of fatigue accumulation exceeds a set threshold, the vibration control unit 222 generates a control signal to start (or continue) the application of vibration, and outputs the control signal to the vibration applying device 171.

### Method of Using Timer

The vibration control unit 222 generates a control signal for controlling the operation of the vibration applying device 171 based on riding time information output from the timer 205, and outputs the control signal to the vibration applying device 171. The vibration control unit 222 estimates the degree of fatigue accumulation on the rider's soles based on the riding time information supplied from the timer 205. When the vibration control unit 222 determines that the estimated degree of fatigue accumulation exceeds a set threshold, the vibration control unit 222 generates a control signal to start (or continue) the application of vibration, and outputs the control signal to the vibration applying device 171.

The timing at which the application of vibration is stopped can be set as desired, and the application of vibration may be stopped, for example, after a predetermined time elapses from the start of the application of vibration. The vibration control unit 222 may determine the timing to stop the application of vibration by comprehensively considering the intensity of vibration, the vibration cycle, the vibration mode, and the like.

Also, the notification unit 210 may be used to notify the rider about the operation of the vibration applying device 171 in advance before the vibration applying device 171 starts or stops applying vibration.

Furthermore, instead of notifying the rider about the operation of the vibration applying device 171 in advance, the vibration control unit 222 requests the rider for permission to operate the vibration applying device 171.

When the vibration control unit 222 determines that the application of vibration by the vibration applying device 171 should be started or stopped, the vibration control unit 222 outputs to the notification unit 210 a notification signal to prompt the rider to determine whether the application of vibration to the rider may be started or stopped. Based on the notification signal, the notification unit 210 outputs an inquiry message as to whether the application of vibration may be started or stopped via a display panel or a speaker (both not shown). Then, when the vibration control unit 222 detects that the command to start or stop the application of vibration has been input by the rider, the vibration control unit 222 generates a control signal to start or stop the application of vibration and outputs the control signal to the vibration applying device 171. With this configuration, it is possible to reduce the inconvenience that the rider feels unpleasant due to a vibration applied or stopped at an unintended timing.

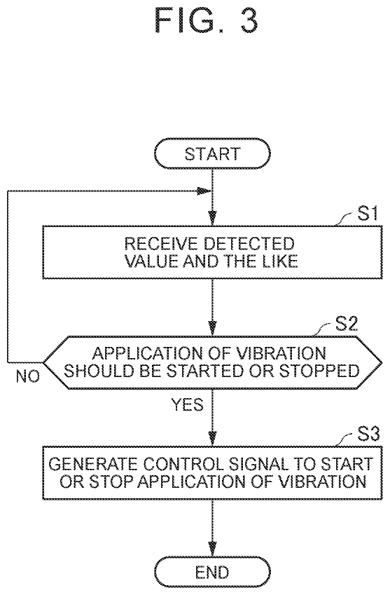

Hereinafter, a process performed by the vibration control unit 222 will be described. FIG. 3 is a flowchart showing a vibration control process. When the vibration control unit 222 receives a detected value and the like output from the input unit 190 or the sensor unit 200 (step S1), the vibration control unit 222 determines whether the timing to start or stop the application of vibration has arrived based on the received detected value and the like (step S2). When the vibration control unit 222 determines that the timing to start or stop the application of vibration has not arrived (step S2; NO), the process returns to step S1. On the other hand, when the vibration control unit 222 determines that the timing to start or stop the application of vibration has arrived (step S2; YES), the vibration control unit 222 generates a control signal to start or stop the application of vibration (step S3), and outputs the control signal to the vibration applying device 171. Then, the process ends.

As described above, according to the embodiment, an effective stimulus (massaging effect) can be provided to the soles of the rider of the mobile inverted pendulum at an appropriate timing, thereby reducing fatigue accumulated on the soles of the rider.

### B. Modification

In the embodiment described above, the configuration that provides the massaging effect to the soles of the rider is illustrated. However, a configuration may be adopted in which the massaging effect is provided to other body parts such as hands of the rider.

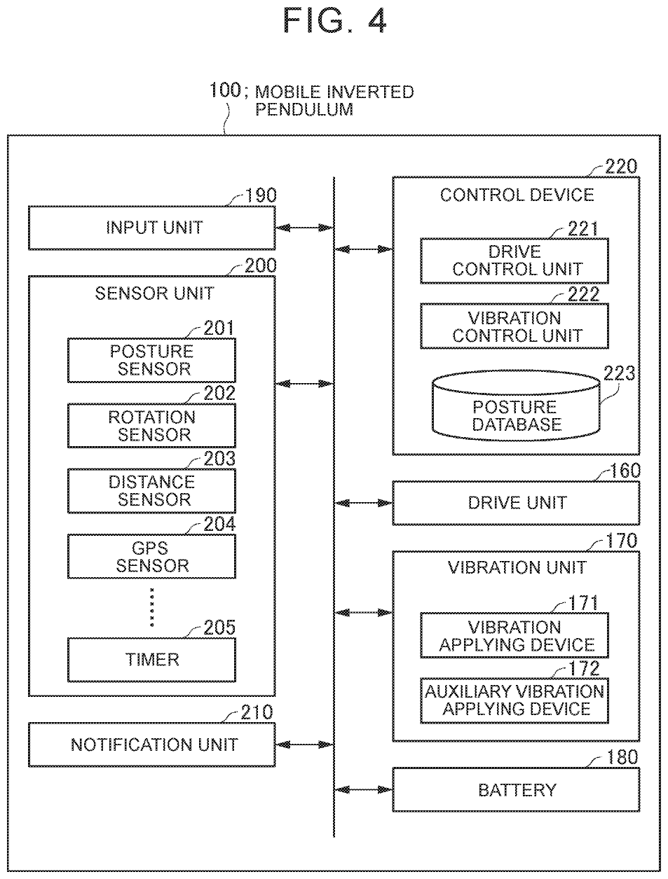

FIG. 4 is a block diagram showing a system configuration of the mobile inverted pendulum 100 according to a modification. The parts corresponding to those in FIG. 2 are assigned with the same reference characters and descriptions thereof will be omitted.

The vibration unit 170 includes an auxiliary vibration applying device 172 for applying vibration to the hands of the rider, in addition to the vibration applying device 171 for applying vibration to the soles. The auxiliary vibration applying device 172 is provided, for example, in the vicinity of the operation handlebar 130. The vibration control unit 222 controls the operations of the vibration applying device 171 and the auxiliary vibration applying device 172, so as to provide a massaging effect not only to the rider's soles but also to the rider's hands.

The method of providing the massaging effect to the rider is not limited to vibration. For example, the massaging effect may be provided using electricity, heat, light, or the like.

Also, the massaging effect may be provided to the rider while the mobile inverted pendulum 100 is stopped as well as while the mobile inverted pendulum 100 is traveling. Furthermore, the disclosure is not limited to the mobile inverted pendulum 100, and is applicable to all types of small mobility ground vehicles.

### C. Others

The disclosure is not limited to the above-described embodiment, and can be implemented in various other forms without departing from the scope of the disclosure. Thus, the embodiment is merely illustration in all respects, and is not interpreted restrictively. For example, the order of the process steps described above may be changed as appropriate, or the process steps may be performed in parallel, as long as no contradiction occurs in content of the process.

In the present specification, the ‘unit_does not simply represent a physical configuration, but also represents a process performed by the “unit”, which is implemented via software. In addition, the process performed by one “unit” may be implemented by two or more physical configurations or devices, and the process performed by two or more “units” may be implemented by a single physical configuration or device.

What is claimed is:

1. A mobile inverted pendulum, comprising:
a step on which a foot of a rider is placed;
a vibration applying device that applies vibration to the step; and
a vibration control unit that controls operation of the vibration applying device.

2. The mobile inverted pendulum according to claim 1, further comprising
a posture sensor that detects a posture angle of the mobile inverted pendulum,
wherein the vibration control unit allows the vibration applying device to apply vibration, when the detected posture angle is within a set allowable range of the posture angle.

3. The mobile inverted pendulum according to claim 2, further comprising
a notification unit that notifies the rider about operation of the vibration applying device before the vibration is applied.

4. The mobile inverted pendulum according to claim 3, further comprising:
an operation handlebar held by the rider; and
an auxiliary vibration applying device that applies vibration to the operation handlebar.

5. The mobile inverted pendulum according to claim 4, further comprising
an input unit through which the rider inputs a control command related to the operation of the vibration applying device,
wherein the vibration control unit controls the operation of the vibration applying device based on the input control command.

6. The mobile inverted pendulum according to claim 4, further comprising:
a distance sensor that measures a moving distance of the mobile inverted pendulum,
wherein the vibration control unit controls the operation of the vibration applying device based on the measured moving distance.

7. The mobile inverted pendulum according to claim 4, further comprising
a timer that measures a riding time of the rider,
wherein the vibration control unit controls the operation of the vibration applying device based on the measured riding time.

8. The mobile inverted pendulum according to claim 1, further comprising
a posture sensor that detects a posture angle of the mobile inverted pendulum,
wherein the vibration control unit stops application of vibration by the vibration applying device, when the detected posture angle falls below a set posture angle threshold with the vibration being applied to the step.

9. The mobile inverted pendulum according to claim 8, further comprising
a notification unit that notifies the rider about operation of the vibration applying device before the vibration is applied.

10. The mobile inverted pendulum according to claim 9, further comprising:
an operation handlebar held by the rider; and
an auxiliary vibration applying device that applies vibration to the operation handlebar.

11. The mobile inverted pendulum according to claim 10, further comprising
an input unit through which the rider inputs a control command related to the operation of the vibration applying device,
wherein the vibration control unit controls the operation of the vibration applying device based on the input control command.

12. The mobile inverted pendulum according to claim 10, further comprising:
a distance sensor that measures a moving distance of the mobile inverted pendulum,
wherein the vibration control unit controls the operation of the vibration applying device based on the measured moving distance.

13. The mobile inverted pendulum according to claim 10, further comprising
a timer that measures a riding time of the rider,
wherein the vibration control unit controls the operation of the vibration applying device based on the measured riding time.
